(19) United States
(12) Patent Application Publication
(10) Pub. No.: US 2008/0037842 A1
(43) Pub. Date: Feb. 14, 2008

(54) Smart Card That Stores Invisible Signatures

(76) Inventors: Srinivas Gutta, Bangalore (IN); Miroslav Trajkovic, Centereach, NY (US); Vasanth Philomin, Stolberg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 10/555,552

(22) PCT Filed: May 6, 2004
(86) PCT No.: PCT/IB04/01391

§ 371 Date: May 18, 2007

Related U.S. Application Data
(60) Provisional application No. 60/469,069, filed on May 8, 2003.

(51) Int. Cl. G06K 9/22

(52) U.S. Cl. 382/119; 726/28

(57) ABSTRACT

A transaction card 10 for use in a transaction includes a memory 15 and pressure sensors 20. The authorized user provides biometric data, such as a signature, by signing on the pressure sensors (20) using a pointer for storage in the memory (15) when the card is used for the first time. The signature is not visible on the card for added security. At the point of use of the transaction card (10), such as the point of sale, the user signs on an input device (50) such as a digital tablet, a tablet with pressure sensors or a slip of paper. This newly acquired signature (55) is compared with the signature stored on the transaction card (10), such as by displaying the stored signature out of the view of the user and comparing displayed signature with the acquired signature (55). The comparison may be performed by the service-providing associate or by a processor coupled to the input device (50).

The invention relates to memory cards and security methods, and more particularly, to methods and smart cards that store invisible signatures of authorized users.

Currently, when a new credit card is received in the mail, the provider asks the authorized user to sign on the back of the card so that when the authorized user purchases an item, it is easy for the sales associate to authenticate the transaction by comparing the signature on the card with an acquired signature signed by the user at the point of sale/use. Many enterprises, such as those dealing with credit cards, or any other type of card or device for secure transactions, are introducing added security. For example, to help merchants in better validating transactions, certain card providers include on the card itself the picture of the authorized user in addition to the signature shown on the card. However, some authorized users are not comfortable with this feature for privacy and other reasons. Further, the authorized user's identity can be more easily stolen if the card is lost. Accordingly, there is a need for more secure and user friendly transaction methods and cards.

According to one embodiment of the invention, a transaction card includes pressure sensors and a memory. The authorized user provides biometric data, such as a signature, through the pressure sensors for storage in the memory when the card is used for the first time. The signature is not visible on the card for added security where, for example, the user signs on the area of the pressure sensors using a pointer. At the point of use of the transaction card, such as the point of sale, the user signs on an input device such as the sales slip, a digital tablet or a tablet with pressure sensors. This newly acquired signature is compared with the signature stored on the transaction card, such as by displaying the stored signature and comparing it with the acquired signature. The comparison may be performed by a clerk or by a processor coupled to the input device. The stored signature is displayed to the sales clerk or service provider out of the view of the card user, for example.

Further features and advantages of the invention will become more readily apparent from a consideration of the following detailed description set forth with reference to the accompanying drawings, which specify and show preferred embodiments of the invention, wherein like elements are designated by identical references throughout the drawings; and in which:

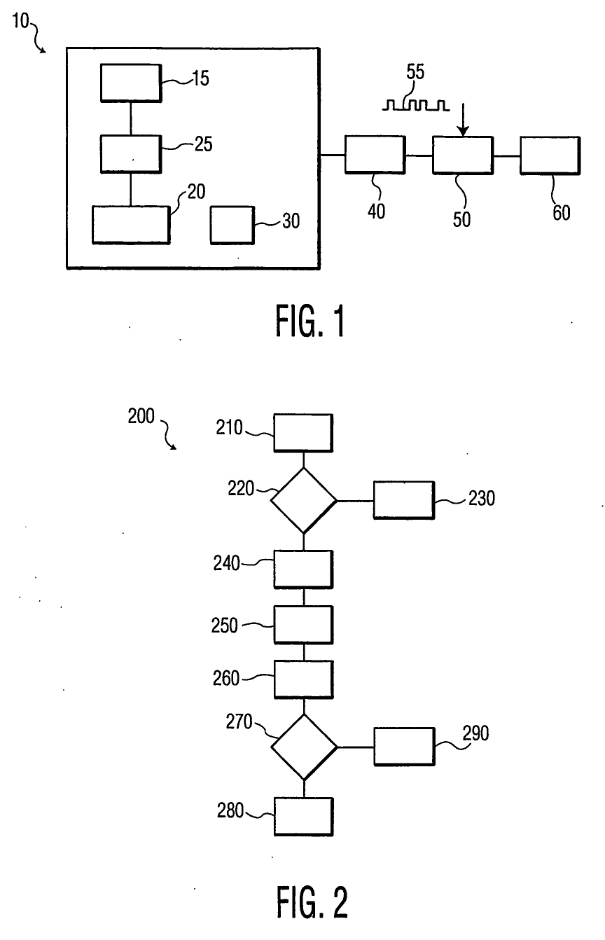

FIG. 1 shows an exemplary transaction card according to present invention; and

FIG. 2 shows an exemplary method for of verifying authorization of a user of a transaction card according to present invention.

A transaction card and method are described where biometric data, including a signature and/or picture of the authorized user for example, are stored on the card but are not visible thereon. This increases security and makes it more difficult to steal one's identity. In use, the transaction card is read by a card reader which displays the stored biometric data, e.g., stored signature and/or picture, to an associate or clerk of the service provider alone, out of the view of the current card holder/user. The service-providing associate compares the stored biometric data with acquired biometric information e.g., the look and/or acquired signature, from the current holder of the card, and proceeds with the transaction if the stored picture and/or signature matches the acquired look and/or signature. The transaction card does not include any visible biometric data of the authorized user(s), and may not even include any visible identification of the authorized user(s), including the name(s) thereof. Instead of having visible information, such as account number(s), name(s) and biometric data of user(s), such information are stored in the memory of the transaction card for enhanced security for display to the service-providing associate at the point of use/sale.

In the following description, numerous specific details are set forth, such as specific type of transaction cards, devices connected to the transaction card, and biometric data. However, it will be obvious to one skilled in the art that the present invention may be practiced without these specific details or with other similar items. In other instances, well known systems have not been set forth in detail in order to not unnecessarily obscure the present invention.

The illustrative embodiments described herein are embodiments of a case where the present invention is applied to performing wide range of secure and private transactions, including accessing secure data, such as personal and/or account information, stored on the transaction card, a computer, a server and/or a network. The secure transactions include sales or purchase, banking, credit card or other financial transactions, insurance, medical or other secure transactions such as accessing automatic teller machines configured with devices that acquire biometric information 55 as will be described. Thus, the transaction card may be used for multiple applications for accessing multiple secure data and transactions. Further, the transaction card may be used by multiple authorized users. The level of security may also be varied, requiring different types and amounts of acquired biometric information. For example, a signature may be enough for low security transactions, while other biometric data may be required for higher security transactions, where the biometrics may be voice print, eye or retinal scan, palm print, finger print, and/or finger length of the authorized user(s) or any other data that identifies the authorized user(s).

In one embodiment shown in FIG. 1, a transaction card 10 for use in transactions comprises a memory structure 15 and an area with an abundance of pressure sensors 20. Illustratively, the memory structure 15 includes an EPROM portion in which data can only be written and never erased or updated, and an EEPROM portion in which data can be erased and updated. Either or both memory portions may be configured to store biometric data of an authorized user(s) of the transaction card 10 and other information, such as secure data including personal information and/or account information of the authorized user or users. Thus, biometric and other secure data of multiple authorized users may be stored in the memory 15, thereby providing a versatile transaction card 10 used for multiple applications by multiple authorized users. For example, the transaction card 10 may be configured by the provider to accept and store biometric data of a predetermined number of authorized users, and to prevent storing in the memory 15 additional biometric information of additional authorized users that exceed the predetermined number.

The memory 15 also includes instructions and an operating system for a processor or controller 25 which is coupled to both the memory 15 and pressure sensors 20. For example, the pressure sensors 20 are coupled to the memory 15 through the processor or controller 25 and are configured to capture biometric data of the authorized user(s) and store the biometric data in the memory 15 when the card is used for the first time by each authorized user, for example, when an authorized user signs for the first time on the pressure sensors 20. Once the signature of a particular authorized user is stored in the memory 15, a subsequent signing by the same particular authorized user on the pressure sensors 20 will not result in storage of this subsequent signature in the memory 15.

Illustratively, the biometric data includes the signature(s) of authorized user(s), who signs on the area of the pressure sensors 20 using a pointer for example. Thus, the signature is not visible on the card 10, but is stored in the memory 15 when the user signs for the first time. Accordingly, the processor 25 is configured to read the biometric data of the authorized user, and store the biometric data in the memory 15 when the authorized user inputs the biometric data, e.g., signs on the pressure sensors 20, for the first time. Thus, the processor 25 is configured to prevent storing in the memory 15 any additional data received from the pressures sensors 20 once the biometric data have been stored in the memory 15. Additional biometric data may also be stored in the memory 15, for example, by the card provider who asks the user to provide such additional biometric data, which may be the user's picture, voice print, eye or retinal scan, palm print, finger print, skin chemistry, and/or finger(s) length of the authorized user(s) or any other data that identifies the authorized user(s).

In summary, the memory 15 may include biometric data or other secure data stored on the card by the card provider, as well as biometric and other secure data are stored in the memory 15 only when the transaction card 10 is used for the first time by each authorized user, where the particular authorized user's biometric data or other secure data have not yet been stored in the memory 15 of the transaction card 10. To that end, the processor 25 is configured to prevent storing in the memory 15 biometrics that are already stored by first checking if such biometrics are already stored in the memory 15.

In an another embodiment, the processor 25 is configured to store the biometric data in the memory 15 after the authorized user accepts storage of the biometric data. For example, the user may accept storage by applying pressure to a particular area of the pressure sensors 20. Alternatively, a separate area of additional pressure sensors 30 may be provided on the card 10, where the biometric data will be stored only if no data for that particular user had already been stored and the user accepts storage by pressing on the additional pressure sensors 30. Further, the processor 25 may also be configured to prompt the authorized user to provide such a storage acceptance or confirmation of the biometric data prior to storing thereof in the memory 15. Such a prompt may include energizing a light source, such as light emitting diodes, near or surrounding the additional pressure sensors 30, for example, or near other areas having pressure sensors marked with appropriate markings such as ‘accept’ or ‘store’.

For added security, the biometric and other secure data may be stored in the memory 15 in an encrypted form using well known encryption techniques using random number, public and private keys, hashing functions used to generate biometric keys for well know encryption algorithm, such as DES, triple-DES, and the like, as disclosed in U.S. Patent Application Publication Numbers US 2002/0,124,176 and US 2002/0,196,963, as well as U.S. Pat. Nos. 6,011,858 and 5,355,411, which are incorporated herein by reference in their entirety. For brevity, various details which are not directly related to the present invention, such as different encryption techniques, are not included herein, but are well known in the art.

In one embodiment, the pressure sensors 20 include digitizers or are coupled to digitizers that capture not only the static signature, but also the writing style and movement with different pressure varying levels for storage in the memory 15, and for later comparison with the signature at the point of sale/use. Modules with such pressure sensors are available such as the Sign Smart™ by SOFTRO, as well as other modules with pressure sensors from Fidelica Microsystems, Inc.

During subsequent uses, the user couples e.g., swipes, slides or inserts, the transaction card 10 in a card reader 40, located at the point of sale/use. The card reader 40 accesses the processor 25 and/or memory 15 for reading the biometric data stored in the memory 15 of the transaction card 10. An input device 50 also located at the point of sale/use is configured to obtain biometric information 55 from the authorized user for comparison with the biometric data stored in the memory 15 and retrieved thereform by the card reader 40. The input device 50 may be any appropriate device configured to acquire biometric information 55 related to the biometric data stored in the memory 15, such as a scanner, recorder, digital tablet or camera for acquiring biometric data 55 picture, voice print, eye or retinal scan, palm print, finger print, skin chemistry, and/or finger(s) length of the authorized user(s) or any other data that identifies the authorized user(s). The biometric data stored in the memory 55 is at least of the same type as the acquired biometric data 55.

The input device 50 may be combined with the card reader 40 or may be coupled thereto. Alternatively, the input device 50 is not coupled to the card reader 40; rather both the input device 50 and the card reader 40 are coupled to a display 60, or a device having a display. Alternatively, the display 60 may be integrated into the input device 50 and/or the card reader 40. The biometric data stored in the memory 15 is compared with the acquired biometric information 55 by a device or a clerk/associate at the point of sale/use, and the transaction is allowed to be continued or completed when there is a match between the stored and acquired biometrics 55.

FIG. 2 shows a flow chart 200 of another embodiment including a method of verifying authorization of a user of the transaction card 10 to conduct secure, personal or confidential transactions. In block 210, the authorized user provides biometric data, such as by signing on the pressure sensors 20 of the transaction card 10 using a pointer for example. Alternatively, or in addition, the user may provide biometric data to the input device 50 at the point of sale/use when using the card for the first time where the processor 25 allows the biometric data to be transferred and stored in the memory 15 of transaction card 10, or the user provides biometric data to the card provider who stores the biometric data in the memory 15 and then provides the transaction card 10 to the user, for example.

In block 220, the processor 25 compares the provided data with data stored in the memory 15. If there is a match indicating that the provided data or similar data for the particular user is already stored in the memory 15, then the process 200 proceeds to block 230 where it ends or is stopped, thus the data provided is block 210 is not stored in the memory 15. That is, the processor 25 prevents storage of the provided data in the memory 15.

If the comparison of block 220 results in no match, thus indicating that the particular biometric data of the particular user is being provided for the first time, then the process 200 proceeds to block 240 where the processor 25 allows storage of the provided data in the memory 15.

In block 250, the stored biometric data is read by an appropriate card reader 40 at the point of sale/use. In block 260, new biometric information is acquired or received from the user by an appropriate input device 50 at the point of sale/use. In block 270, the stored and acquired biometric data are compared, e.g., by a service provider clerk or a processor of the input device for example. Illustratively, the biometric data retrieved from the memory 15, such as the signature, picture and/or other data, is displayed on a display 60 for comparison with the acquired data, e.g., by the service-providing associate at the point of sale/use can.

If the comparison of block 270 results in a match between the stored/retrieved data and the acquired data, the transaction is continued as indicated in block 280. Otherwise, the process 200 is stopped and ends as indicated in block 290.

Finally, the above-discussion is intended to be merely illustrative of the present invention and should not be construed as limiting the appended claims to any particular embodiment or group of embodiments. For example, the processor 25 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the above systems utilized for identifying the presence and identity of the user may be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A transaction card for use in a transaction comprising: a memory which is configured to store biometric data of an authorized user of said transaction card; and pressure sensors coupled to said memory, said pressure sensors being configured to capture said biometric data of said authorized user and store said biometric data in said memory.

2. The transaction card 10 of claim 1, wherein said biometric data is not visible on said transaction card.

3. The transaction card of claim 1, further comprising a processor configured to read said biometric data of said authorized user, and store said biometric data in said memory when said authorized user inputs said biometric data for a first time.

4. The transaction card of claim 3, wherein said processor is configured to prevent storing in said memory data received from said pressures sensors once said biometric data have been stored in said memory.

5. The transaction card of claim 3, wherein said processor is configured to store said biometric data after said authorized user accepts storage of said biometric data.

6. The transaction card of claim 3, wherein said processor is configured to prompt said authorized user to provide a storage confirmation of said biometric data prior to storing said biometric data in said memory 15.

7. The transaction card of claim 6, wherein said processor is configured to store said biometric information after receiving said storage confirmation.

8. The transaction card of claim 6, wherein said storage confirmation is provided through at least one of said pressure sensors.

9. The transaction card of claim 6, wherein said processor 25 is configured to store said biometric data after receiving said storage confirmation through at least a further pressure sensor.

10. The transaction card of claim 1, wherein said biometric data includes a signature of said authorized user.

11. The transaction card of claim 10, wherein said pressure sensors are further configured to capture parameters of said signature, said parameters including at least one of writing style and pressure levels of said signature.

12. The transaction card of claim 1, wherein said pressure sensors are further configured to capture parameters of said biometric data.

13. The transaction card of claim 12, wherein said pressure points include variable pressure levels.

14. The transaction card of claim 1, wherein said memory includes further biometric data of at least one additional authorized user.

15. The transaction card of claim 1, further comprising a processor configured to read biometric information of a predetermined number of authorized users, and stores said biometric information in said memory when said authorized users provide said biometric information for a first time.

16. The transaction card of claim 15, wherein said processor is configured to prevent storing in said memory additional biometric information of additional authorized users that exceed said predetermined number.

17. A transaction card for use in a transaction comprising: memory means for storing biometric data of an authorized user of said transaction card; and sensing means for capturing said biometric data of said authorized user and store said biometric data in said memory means.

18. An authenticating system for authenticating an authorized user comprising: a transaction card for use in a transaction, said transaction card having a memory and a processor, said memory being configured to store biometric data of said authorized user of said transaction card, wherein said transaction card includes pressure sensors coupled to said memory, said pressure sensors being configured to capture said biometric data of said authorized user and store said biometric data in said memory; and a card reader configured to read said biometric data from said memory.

19. The authenticating system of claim 18, further comprising an input device configured to obtain biometric information from said authorized user for comparison with said biometric data and completion of said transaction.

20. The authenticating system of claim 19, wherein said biometric data stored in said memory is visible on said input device.

21. The authenticating system of claim 18, further comprising a display configured to display said biometric data stored in said memory.

22. A method of verifying authorization of a user of a transaction card to perform a transaction comprising: providing biometric data of said authorized user through pressure sensors of said transaction card; storing said biometric data in a memory of said transaction card; reading said biometric data by an input device; and receiving a biometric information of said authorized user by said input device for comparison with said biometric data.

23. The method of claim 22, wherein said storing act is performed when said transaction card is used for a first time.

24. The method of claim 22, further comprising: displaying said biometric data; and allowing said transaction when a match between said biometric information and said biometric data is determined.
